(19) United States
(12) Patent Application Publication
(10) Pub. No.: US 2004/0099853 A1
(43) Pub. Date: May 27, 2004

(54) Self-limiting electric winch assembly

(75) Inventor: David C. Verakis, Florence, KY (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(73) Assignee: Campbell Hausfeld/Scott Fetzer Company, Harrison, OH

(21) Appl. No.: 10/718,872

(22) Filed: Nov. 21, 2003

Related U.S. Application Data
(60) Provisional application No. 60/429,580, filed on Nov. 27, 2002.

(51) Int. Cl. B66D 1/14

(52) U.S. Cl. 254/343

(57) ABSTRACT

A winch for use in a folding camper for raising and lowering the camper, includes a reversible electric motor mounted on a chassis with a threaded rod being rotationally coupled through the electric motor. A winch spool is also rotatably coupled with the electric motor and is adapted to receive a cable used in raising and lowering the camper. A trigger mechanism is threadably engaged with a threaded rod and adapted for linear movement along the threaded rod upon rotation of the threaded rod and at least one limit switch is positioned adjacent to the threaded rod which is electrically coupled to the electric motor such that upon activation of the limit switch by the trigger mechanism, the electric motor is deactivated to stop rotation of the threaded rod and the winch spool. In the preferred embodiment, there are two limits switches to deactivate the motor in either of its reversible directions.

### CROSS REFERENCE TO RELATED APPLICATION

This application claims the benefit of U.S. provisional application No. 60/429,580 filed 27 Nov. 2002, which application is hereby incorporated by reference as if fully disclosed herein.

### BACKGROUND OF THE INVENTION

1. Field of the Invention

This invention relates generally to a winch assembly, and more specifically to a winch assembly including a mechanism for limiting the extent of rotation thereof for use in folding campers.

2. Description of Related Art

The body of a typical folding camping trailer typically comprises a peripheral bottom portion and a peripheral upper portion that is extended above the bottom portion to provide headroom when the camper is utilized for camping. The upper portion typically includes a peripheral framework that at least partially forms a top of the camper and a flexible sheet material that extends between the camper top and the bottom portion. When not being utilized for camping the upper portion can be retracted downwardly towards the bottom portion thereby collapsing the camper and making it more compact for storage and transport.

In many folding campers, the peripheral framework of the upper portion is raised and lowered relative to the bottom portion by a winch, cable and pulley system. An electric motor is typically coupled to a winch located at one end of the camper. One or more cables that extend from the winch spool are routed within the body of the camper around one or more pulleys as applicable and are fixedly terminated at a location within the body. Operationally, to raise the upper portion relative to the bottom portion, the winch pulls and wraps the cable(s) around its spool causing the cables to pull the peripheral framework of the upper portion upwardly. Generally, one or more limit switches are positioned within the body remotely from the winch and the associated electric motor. When the upper portion is raised to a predetermined height or position, the one or more limit switches are triggered, thereby activating a relay that deactivates the electric motor. Further, a brake mechanism may be activated to hold the upper portion in place. Conversely, to lower and retract the upper portion, the brake mechanism is released and the electric motor is activated to rotate the winch in the opposite direction to unwind the cable from the winch shaft. When the upper portion is lowered into its predetermined retracted position, the one or more limit switches are triggered to activate the relay that deactivates the electric motor and stops the winch.

### BRIEF SUMMARY OF THE INVENTION

A winch assembly for use with a foldable camper is described. One embodiment of the winch assembly includes an electric motor that is rotationally coupled to a threaded rod and a winch spool. The winch spool is adapted to receive one or more cables. A trigger is threadably engaged with the threaded rod for linear movement along the threaded rod upon rotation of the threaded rod. At least one limit switch electrically coupled to the electric motor is positioned generally proximate the threaded rod for activation by the trigger, wherein activation of the at least one limit switch deactivates the electric motor and stops the rotational motion of the threaded rod and the winch spool.

Other embodiments and variations thereof are contemplated and described below and in the appended claims.

### BRIEF DESCRIPTION OF THE DRAWINGS

FIG. 1 is an isometric view of a folding camper in the retracted position.

FIG. 2 is an isometric view of the folding camper in the extended position.

FIG. 3 is a top view of the winch, cable and pulley system of the camper that is utilized to raise the upper portion of the camper into its extended position.

FIG. 4 is a partial cross sectional view taken along line 4-4 of FIG. 3 illustrating the camper with the upper portion of the camper in the retracted position.

FIG. 5 is a partial cross sectional view taken along line 4-4 of FIG. 3 illustrating the camper with the upper portion of the camper in the extended position.

FIG. 6 is an isometric view of the winch assembly.

FIG. 7 is a side view of the winch assembly taken along line 7-7 of FIG. 6.

FIG. 8 is a front view of the winch assembly taken along line 8-8 of FIG. 6.

FIG. 9 is a schematic showing an electrical circuit utilized by one embodiment of the winch assembly.

FIG. 10 is a cross sectional view of the winch assembly taken along line 10-10 of FIG. 7 showing the position of the trigger plate when the upper portion of the camper is in the retracted position.

FIG. 11 is a cross sectional view of the winch assembly taken along line 10-10 of FIG. 7 showing the position of the trigger plate when the upper portion of the camper is between the retracted and extended positions.

FIG. 12 is a cross sectional view of the winch assembly taken along lines 10-10 of FIG. 7 showing the position of the trigger plate when the upper portion of the camper is in the extended position.

### DETAILED DESCRIPTION OF THE INVENTION

A winch assembly for use in a folding camper is described. Preferred embodiments of the winch assembly include one or more limit switches in conjunction with a trigger mechanism driven by a threaded rod to effectively control the maximum extension and the full retraction of the upper portion of the folding camper. By placing the one or more limit switches on the winch assembly, the need for remotely mounted limit switches, associated electric wires and relays is eliminated, thereby simplifying assembly of the camper, potentially improving reliability, reducing cost, and increasing the ease of adjusting the camper's extended and retracted position limits.

In other preferred embodiments, the winch assembly's electric motor is coupled to the winch spool and the threaded rod through a worm gear assembly. A worm is attached to the shaft of the electric motor and is mated with a worm gear having angled teeth to match the thread of the worm. A worm gear assembly of this configuration prevents the worm from being back driven by a force exerted on it by the mating worm gear. Accordingly, the need for a brake, ratchet mechanism or clutch to hold the upper portion in its extended position is eliminated.

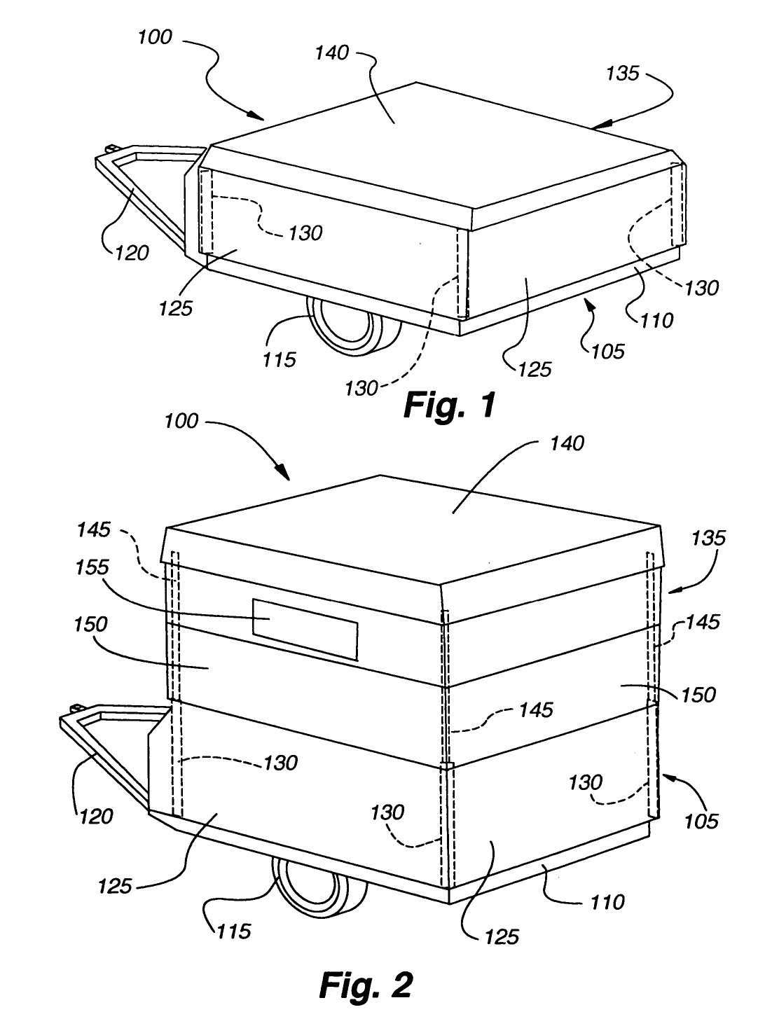

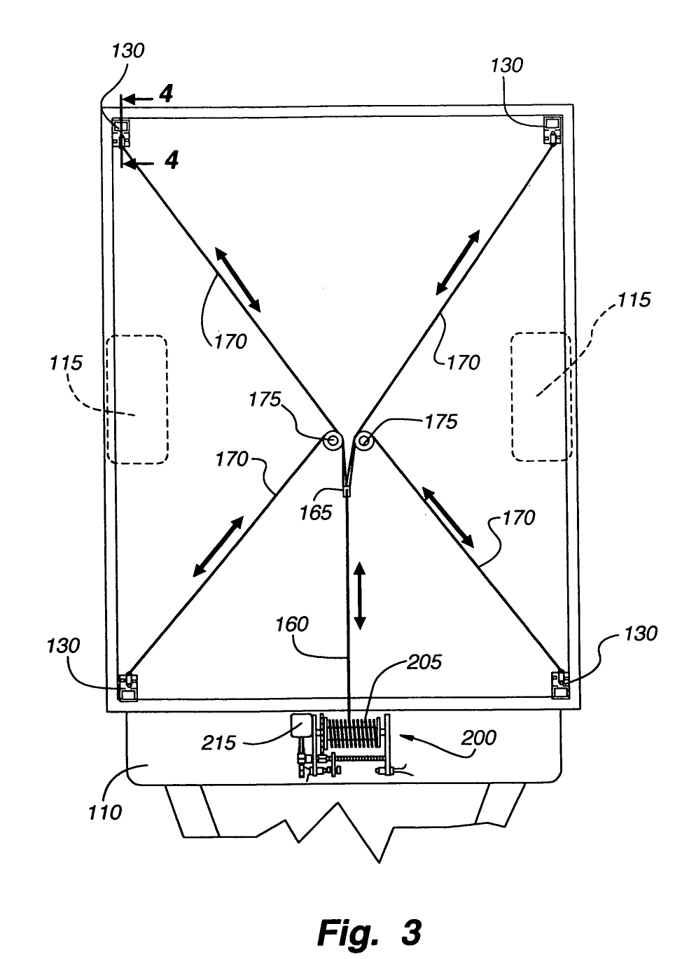

FIGS. 1-5 illustrate a typical folding camper 100 according to one embodiment of the present invention. The camper includes a bottom portion 105 having a support framework 110 to which wheels 1 15 are attached to facilitate transport. Further, the support framework may include a forwardly extending section 120 through which the camper can be attached to a vehicle, generally by way of a hitch. The bottom portion typically has four interconnected rigid sides 125 that with a bottom side, which rests upon or is integral with the support framework, form an open topped box-like structure. Proximate each intersecting corner of the sides a elongated rigid generally tubular support member 130 extends from the support framework vertically upwardly, terminating near the top edge of the bottom portion (see FIGS. 3-5).

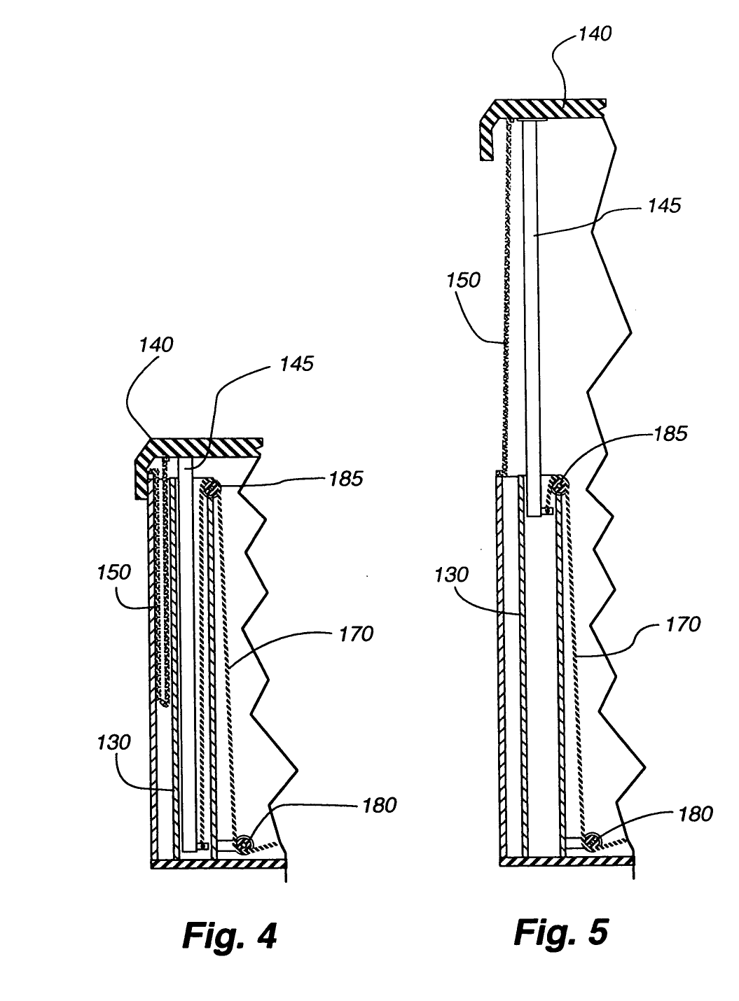

The camper further includes an upper portion 135 having extended and retracted positions. In the retracted position, a rigid top 140 of the upper portion rests upon and can extend over the top edges of the bottom portion 105 (FIGS. 1 and 4). Vertical downwardly-extending elongated rigid members 145 are attached to the top and are received in a corresponding support member 130 of the bottom portion. The upper portion further includes flexible sides 150 that extend from the top edges of the bottom portion to the top of the upper portion. The flexible sides are typically comprised of a fabric material, such as canvas or nylon. The sides may include one or more windows 155 made of a transparent plastic material. When in the retracted position, the flexible sides fold and are received in the bottom portion (FIG. 4).

To move the upper portion into its extended position, the elongated rigid members 145 are slid upwardly and generally above of the tubular support members 130 by a winch and cable system (described below). As the upper portion is moved into the extended or raised position, the flexible sides 150 are extracted from inside the bottom portion and are pulled upwardly by the top 140 until they are in a generally vertical orientation extending between the top edge of the bottom portion 105 and the top 140 (FIG. 5).

Referring primarily to FIGS. 3-5, the winch and cable system includes a winch assembly 200 mounted to the support framework 1 10 at one end of the camper. A primary cable 160 is attached to a spool 205 of the winch assembly at a first end. The other end of the primary cable terminates at a coupling 165 that has the ends of four lift cables 170 attached thereto. Each of the lift cables is passed around a central pulley 175, which is typically attached to the support framework 110, and extends outwardly to a corner of the camper 100. Proximate the base or lower end of a corresponding elongated tubular support member 130, each lift cable is directed upwardly around a lower pulley 180 toward the top of the associated tubular support member. At the top of the associated tubular support member the cable is redirected downwardly within the support member after passing around an upper pulley 185. The end of the cable is attached to a corresponding rigid member 145 of the upper portion proximate the bottom end thereof.

Operationally, to raise the upper portion 135 into its extended position, the primary cable 160 is wound onto the winch spool 205, thereby pulling the lift cables 170 around the associated central pulley 175. Accordingly, the cables pull the associated elongated rigid members 145 upwardly within the elongated tubular support members 130 until the upper portion of the camper is fully extended as shown in FIGS. 2 and 5. Conversely, to lower the upper portion, the primary cable is unwound from the winch spool, allowing the weight of the upper portion to force it downwardly.

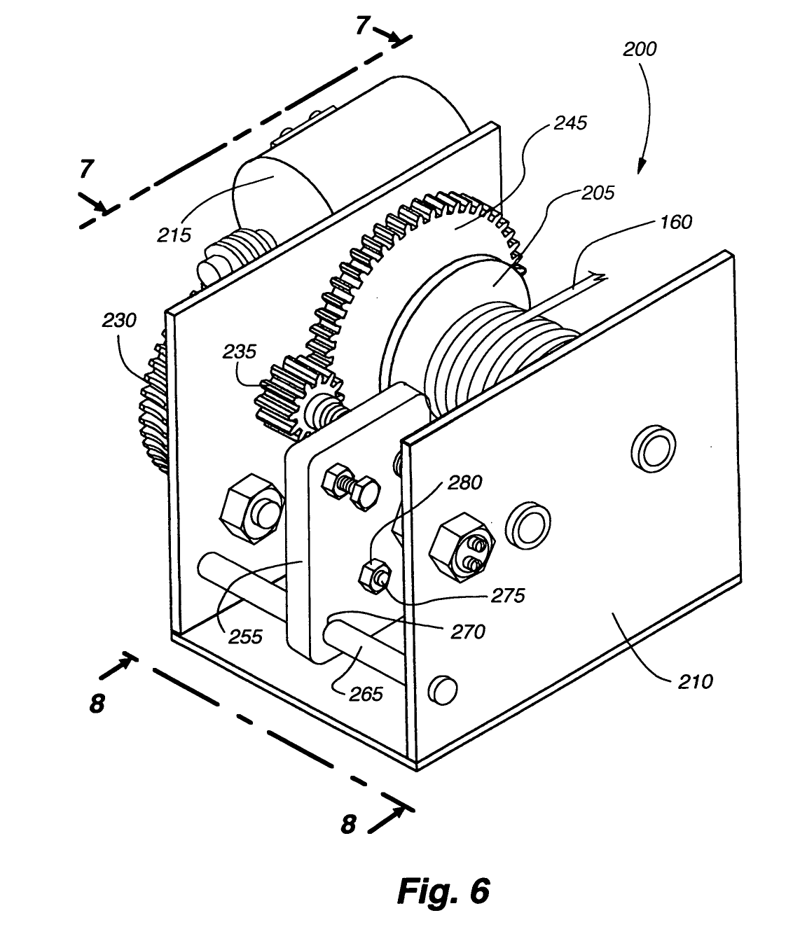

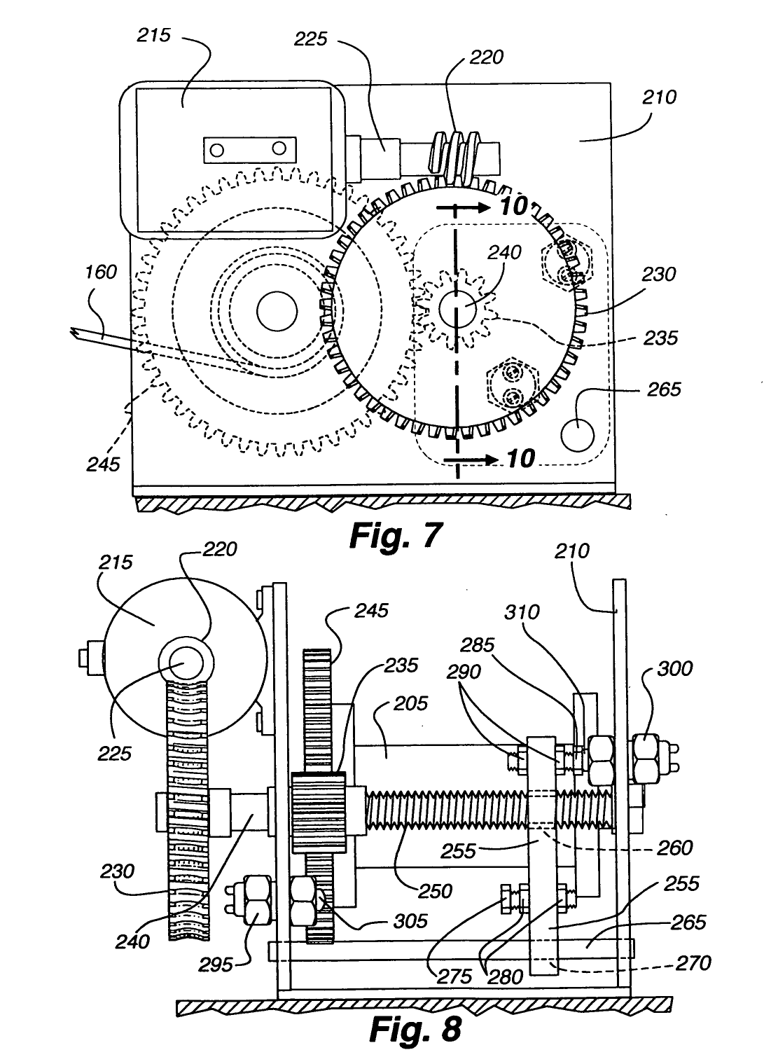

A winch assembly 200 incorporating a preferred limiting mechanism in accordance with the present invention is illustrated in FIGS. 6-8. The assembly includes an upwardly opening C-shaped chassis 210 with an electric motor 215 mounted on an exterior side thereof. A worm 220 is mounted to the output shaft 225 of the motor and interfaces or meshes with a worm gear 230. The worm gear is rotatably mounted on the chassis and is coupled to a first spur gear 235 on a gear shaft 240. The first spur gear 235 is smaller than the worm gear 230. The first spur gear is meshed with a larger second spur gear 245 that is fixedly attached to the winch spool 205 around which the primary cable 160 is wound or unwound. The second spur gear and spool are rotatably mounted on the chassis. It is to be appreciated that the relative size of the worm, worm gear and spur gears, the gear mating configuration and number of gears can vary depending on, but not limited to, the motor's specifications, the weight of the upper portion of the camper, and the desired rate of extension or retraction of the upper portion of the camper 100.

Referring primarily to FIG. 8, a threaded screw shaft 250 is fixed to the gear shaft 240 along a coincidental axis of rotation. A plate 255 is threadably received on to the threaded screw shaft through a correspondingly threaded aperture 260 in the plate. The plate is also rotationally fixed by a guide rod 265 that is secured to the chassis and slidably passes through a second aperture 270 in the plate. Accordingly, as the threaded shaft is rotated, the plate will be linearly driven either leftwardly or rightwardly depending on the direction of the rotation of the threaded shaft. A first bolt 275 with a leftwardly facing head is secured to the plate through a third aperture by a pair of associated nuts 280, and a second bolt 285 with a rightwardly facing head is secured to the plate through a fourth aperture by associated nuts 290. By loosening the nuts, the distance of the bolt heads from the corresponding surface of the plate can be adjusted for reasons that will become apparent below.

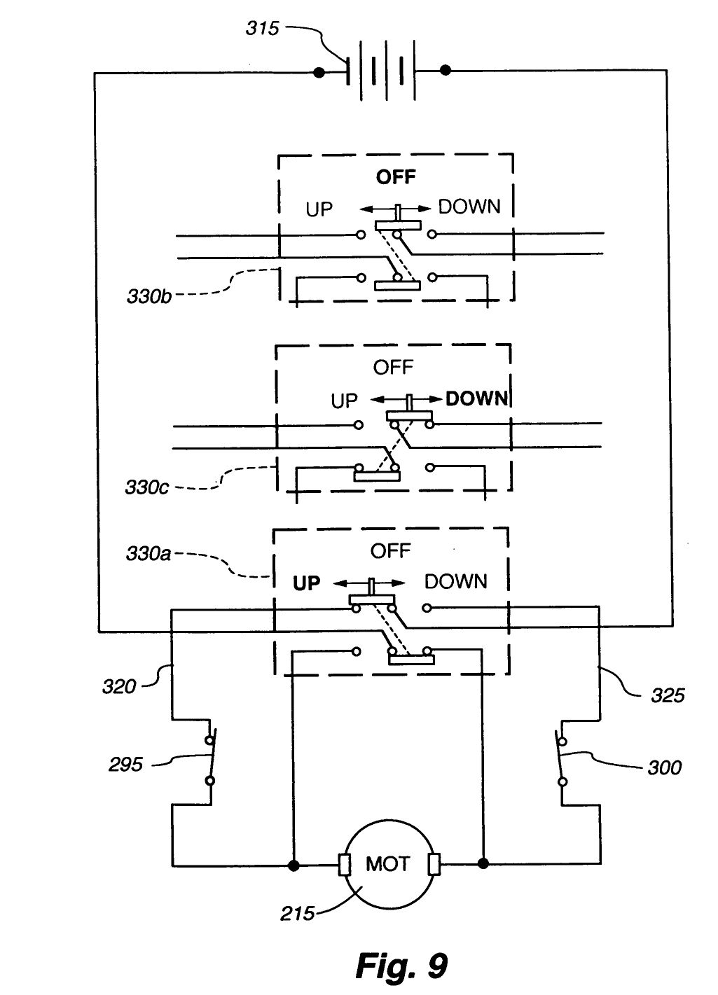

On opposing sides of the C-shaped chassis 210, normally closed left and right switches 295 and 300 are mounted with their button heads 305 and 310 facing the corresponding head of the first and second bolts 275 and 285 respectively. The switches are electronically coupled to the electric motor as is best illustrated in the schematic of FIG. 9. The electric motor 215 is electrically coupled to a 12 v battery 315 by way either of a first or second circuit path 320 and 325 through a three way switch 330. In the “up” position 330a of the three way switch, current flows through the motor in a first direction along the first circuit path causing the motor shaft to rotate in a clockwise direction thereby winding the primary cable 160 onto the winch spool 205 and raising the upper portion 135 of the camper. Conversely, in the “down” position 330c of the three way switch, current flows through the motor in the opposite direction along the second circuit path causing the motor shaft to rotate in a counterclockwise direction thereby unwinding the primary cable from the winch spool and retracting or lowering the upper portion of the camper. If the three way switch is placed in the center “off” position 330b, no current flows to the motor and the cables and the associated upper portion remain in whatever position they were in when the current flow was interrupted.

While the three way switch 330 is in either the “up” or “down” position, power continues to flow to the motor through either the first or second current paths provided the respective normally closed first and second switches 295 and 300 are not activated. If respective switch is activated, the current flow to the motor is interrupted and the upper portion 135 of the camper becomes fixed in place. Only by switching the three way switch to cause current to flow to the other current path may the upper portion be moved.

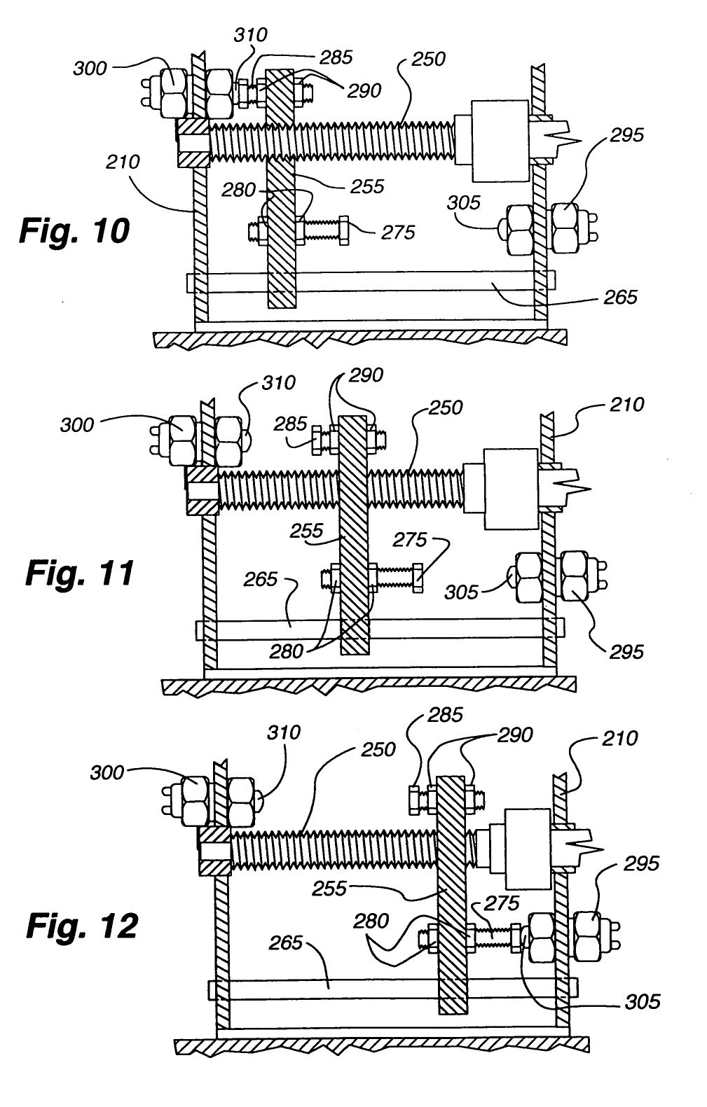

FIG. 10 illustrates the plate 255 with the second bolt 285 depressing the button head 310 of the second switch 300, thereby preventing current from flowing through the second current path 325 of FIG. 9. This position corresponds to the lowered or retracted position of the upper portion 135 of the camper with the primary cable 160 being substantially unwound from the spool 205. By adjusting the position of the second bolt's head the maximum amount of cable that will unwind from the spool can be adjusted. By switching the three way switch 330 into the “up” position, current is directed through the first current path 320 causing the motor 215 to rotate in the clockwise direction correspondingly (i) driving the plate along the screw in the direction of or toward the first switch 295 as shown in FIG. 11, and (ii) winding the primary cable onto the winch spool. Accordingly, the upper portion of the camper is pulled upwardly by the lift cables 170.

The plate 255 moves along the threaded rod a set distance for each revolution of the spool 205. For each revolution of the spool, a certain amount of primary cable 160 is unwound from the spool. The distance of the linear movement of the plate along the threaded rod 250 corresponds to the unwinding or winding of a quantifiable length of primary cable. Further, the primary cable and the associated lift cables 170 must be pulled a certain distance to fully extend the upper portion 135 of the camper. Accordingly, by setting the maximum amount of linear movement of the plate along the threaded rod, the maximum upward extension of the upper portion can be limited. The travel distance of the plate is set by adjusting the position of the first bolt 275 so that its head contacts and presses inwardly the button head 305 of the first switch 295 (FIG. 12) when the plate has moved a distance that corresponds to the fully extended position of the upper portion. When the head of the first bolt depresses the first switch's button head the current flow in the first circuit path 320 is interrupted preventing anymore primary cable from being wound onto the spool and fixing the upper portion in its fully extended position. To lower the upper portion, the three way switch 330 is moved in the “down” position 330c to activate the motor and move the plate 255 in the opposite direction until the second bolt 285 impacts the second switch 300, thereby stopping the winch motor 215.

For the purposes of explanation, numerous specific details have been set forth in the foregoing description concerning specific embodiments in order to provide a thorough understanding of the present invention. The detailed description and embodiments discussed herein are not intended to limit the scope of the invention as claimed. To the contrary, embodiments of the claims have been contemplated that encompass the full breadth of the claim language. Accordingly, the present invention may be practiced without some of the specific detail provided herein. The configuration of the winch assembly can vary significantly utilizing different configurations as would be obvious to one of ordinary skill given the benefit of this disclosure. For example, the gears could be replaced with belts and pulleys. The threaded rod could be positioned axially inline with the winch spool. The plate and associated bolts could be replaced with switch trigger mechanism having a significantly different shape and configuration. The worm and worm gear could be replaced with conventional spur gears with a brake, clutch or ratchet mechanism being provided to hold the spool and the upper portion in the extended position when the motor is stopped. Further, the winch mechanism can be utilized with foldable campers having different types of unfolding mechanisms. Finally, the winch mechanism is not limited to use on folding campers but may be utilized in conjunction with a variety of mechanisms to limit there movement to one or more set positions.

What is claimed is:

1. A winch assembly comprising:
a chassis;
an electric motor mounted to the chassis;
a threaded rod rotationally coupled to the electric motor;
a winch spool, the winch spool being rotationally coupled with the electric motor, the winch spool being adapted to received a cable therearound;
a trigger mechanism, the trigger mechanism being (i) threadably engaged with the threaded rod and (ii) adapted for linear movement along the threaded rod upon rotation of the threaded rod; and
at least one limit switch, the at least one limit switch being (i) electrically coupled to the electric motor, and (ii) mounted on the chassis generally proximate the threaded rod for activation by the trigger mechanism;
wherein activation of the at least one limit switch by the trigger mechanism deactivates the electric motor and stops the rotational motion of the threaded rod and the winch spool.

2. The winch assembly of claim 1, wherein the at least one limit switch comprises first and second limit switches positioned opposite each other, the first limit switch being adapted to stop the electrical motor from rotating the threaded rod in a first direction when activated by the trigger mechanism, and the second limit switch being adapted to stop the electrical motor from rotating the threaded rod in a second direction when activated by the trigger mechanism, the first direction being opposite the second direction.

3. The winch assembly of claim 1, wherein the deactivation trigger comprises a plate.

4. The winch assembly of claim 1, wherein the motor is coupled to the winch spool through at least a worm gear assembly.

5. A foldable camper incorporating the winch assembly of claim 1.
